(19) United States
(12) Patent Application Publication
(10) Pub. No.: US 2025/0056609 A1
(43) Pub. Date: Feb. 13, 2025

(54) WIRELESS COMMUNICATION SYSTEM, WIRELESS COMMUNICATION METHOD, AND BASE STATION

(71) Applicant: NIPPON TELEGRAPH AND TELEPHONE CORPORATION, Tokyo (JP)

(72) Inventors: Riku OMIYA, Musashino-shi, Tokyo (JP); Junichi IWATANI, Musashino-shi, Tokyo (JP); Akira KISHIDA, Musashino-shi, Tokyo (JP); Shinya OTSUKI, Musashino-shi, Tokyo (JP); Yusuke ASAI, Musashino-shi, Tokyo (JP); Tomoaki OGAWA, Musashino-shi, Tokyo (JP); Yasushi TAKATORI, Musashino-shi, Tokyo (JP)

(73) Assignee: NIPPON TELEGRAPH AND TELEPHONE CORPORATION, Tokyo (JP)

(21) Appl. No.: 18/718,831

(22) PCT Filed: Dec. 17, 2021
(86) PCT No.: PCT/JP2021/046835

§ 371 Date: Jun. 12, 2024

(51) Int. Cl. H04W 74/0816; H04W 8/22; H04W 84/12

(52) U.S. Cl. CPC H04W 74/0816; H04W 8/22; H04W 84/12

(57) ABSTRACT

A wireless communication system includes: a first wireless terminal capable of communicating through both a first communication scheme using a first frequency band and a second communication scheme using a second frequency band higher than the first frequency band; a second wireless terminal that is compatible with communication through the first communication scheme and is not compatible with communication through the second communication scheme; and a base station that is compatible with multi-link and accommodating the first wireless terminal and the second wireless terminal. A carrier sense level during transmission in communication between a base station and the first wireless terminal through the first communication scheme is set to a value less than a predetermined value that is a carrier sense level during transmission in communication between the base station and the second wireless terminal through the first communication scheme.

### TECHNICAL FIELD

The present disclosure relates to a wireless communication system, a wireless communication method, and a base station.

### BACKGROUND ART

In recent wireless communication systems, it has been important to increase radio capacity to deal with increasing mobile traffic. For example, in IEEE 802.11be (wireless LAN), one device is equipped with a plurality of different wireless LAN interfaces and adopts a function of establishing a plurality of transmission paths, and such a device is called a multi-link device (MLD) (refer to NPL 1, for example). In addition, in IEEE 802.11be, utilization of a 6 GHz band is considered.

### CITATION LIST

### Non Patent Literature

[NPL 1] EVGENY KHOROV et al. “Current Status and Directions of IEEE 802.11be, the Future Wi-Fi 7,” IEEE Access, VOLUME 8, 2020, Received Apr. 15, 2020, accepted May 1, 2020, date of publication May 8, 2020, date of current version May 21, 2020, pp. 88664-88688

### SUMMARY

### Technical Problem

In a case in which a multi-link device uses existing frequency bands (for example, a 2.4 GHz band and a 5 GHz band) in addition to a new frequency band (for example, a 6 GHz band) which is considered for use, contention occurs between existing devices which are not compatible with multi-link and can use only existing frequency bands. Accordingly, communication speeds of the existing devices are reduced.

The present disclosure was achieved in view of the above-described problem. An object of the present disclosure is to provide a wireless communication system, a wireless communication method, and a base station capable of preventing a communication speed of an existing device which is not compatible with multi-link from decreasing in a case in which a multi-link device using both a low frequency band and a high frequency band and the existing device using the low frequency band coexist.

### Solution to Problem

A wireless communication system according to an embodiment of the present disclosure includes: a first wireless terminal capable of communicating through both a first communication scheme using a first frequency band and a second communication scheme using a second frequency band higher than the first frequency band; a second wireless terminal that is compatible with communication through the first communication scheme and is not compatible with communication through the second communication scheme; and a base station that is compatible with multi-link and accommodates the first wireless terminal and the second wireless terminal. This wireless communication system sets a carrier sense level during transmission in communication between the base station and the first wireless terminal through the first communication scheme to a value less than a predetermined value that is a carrier sense level during transmission in communication between the base station and the second wireless terminal through the first communication scheme.

In addition, a wireless communication method according to an embodiment of the present disclosure is a wireless communication method of controlling a first wireless terminal capable of communicating through both a first communication scheme using a first frequency band and a second communication scheme using a second frequency band higher than the first frequency band, a second wireless terminal that is compatible with communication through the first communication scheme and is not compatible with communication through the second communication scheme, and a multi-link compatible base station accommodating the first wireless terminal and the second wireless terminal. This wireless communication method includes a process of setting a carrier sense level during transmission in communication between the base station and the first wireless terminal through the first communication scheme to a value less than a predetermined value that is a carrier sense level during transmission in communication between the base station and the second wireless terminal through the first communication scheme.

In addition, a base station according to an embodiment of the present disclosure is a base station compatible with multi-link and accommodating a first wireless terminal capable of communicating through both a first communication scheme using a first frequency band and a second communication scheme using a second frequency band higher than the first frequency band, and a second wireless terminal that is compatible with communication through the first communication scheme and is not compatible with communication through the second communication scheme. This base station sets a carrier sense level in communication between the base station and the first wireless terminal through the first communication scheme to a value less than a predetermined value that is a carrier sense level in communication between the base station and the second wireless terminal through the first communication scheme.

### Advantageous Effects

According to the present disclosure, in a case in which a multi-link device using both a low frequency band and a high frequency band and an existing device which is not compatible with multi-link and uses the low frequency band coexist, a communication speed of the existing device can be prevented from decreasing.

### BRIEF DESCRIPTION OF DRAWINGS

FIG. 1 is a diagram showing a configuration example of a wireless communication system according to embodiment 1.

FIG. 2 is a diagram showing a specific configuration example of a base station according to embodiment 1.

FIG. 3 is a diagram showing a specific configuration example of a control device for controlling the base station according to embodiment 1.

FIG. 4 is a diagram showing a hardware configuration example of the control device for controlling the base station according to embodiment 1.

FIG. 5 is a flowchart showing an operation example of the wireless communication system according to embodiment 1.

### DESCRIPTION OF EMBODIMENTS

Embodiments will be described hereinafter with reference to the accompanying drawings. Redundant descriptions will be appropriately simplified or omitted. The present disclosure is not limited to the embodiments described below. The present disclosure may include various modifications and combinations of configurations disclosed in the following embodiments without departing from the spirit of the present disclosure.

### Embodiment 1

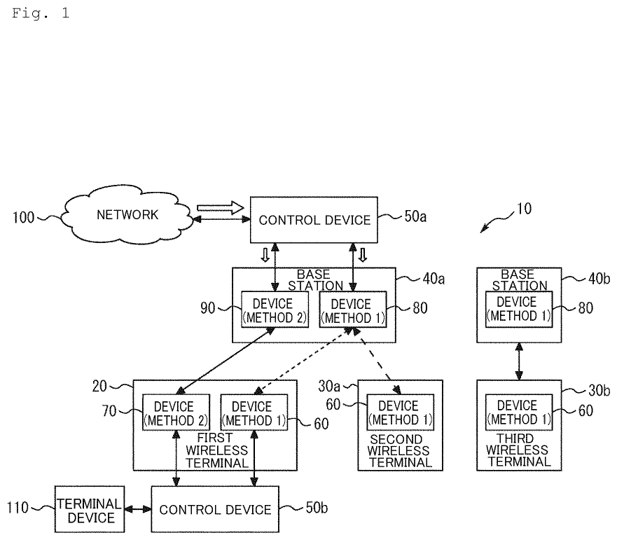

FIG. 1 is a diagram showing a configuration of a wireless communication system 10 according to embodiment 1. As shown in FIG. 1, the wireless communication system 10 is connected to a network 100. The wireless communication system 10 includes, for example, a first wireless terminal 20, a second wireless terminal 30a, a third wireless terminal 30b, a base station 40a, a base station 40b, a control device 50a, a control device 50b, and a terminal device 110.

The control device 50a is connected to the network 100 and controls the base station 40a such that wireless communication between the base station 40a and the first wireless terminal 20, and wireless communication between the base station 40a and the second wireless terminal 30a are both performed.

The base station 40a is a multi-link compatible device, or a so-called multi-link device. The base station 40a includes a device 80 serving as an access point (AP) of communication according to a first communication scheme (also described as scheme 1 in the present specification) and a device 90 serving as an AP of a second communication scheme (also described as scheme 2 in the present specification). The base station 40a performs wireless communication with each of the first wireless terminal 20 and the second wireless terminal 30a according to control of the control device 50a.

Schemes 1 and 2 are, for example, wireless communication schemes conforming to a wireless LAN standard. Scheme 1 is, for example, a 5 GHz band wireless communication scheme in IEEE 802.11. Scheme 2 is, for example, a 6 GHz band wireless communication scheme in IEEE 802.11. A multi-link device can perform wireless communication by simultaneously using schemes 1 and 2.

The base station 40a may be configured integrally with the control device 50a. That is, the base station 40a may have each function of the control device 50a.

The first wireless terminal 20 is a multi-link device. The first wireless terminal 20 is a wireless terminal compatible with multi-link and serves as a station (STA) that performs communication with an AP included in the base station. The first wireless terminal 20 includes a device 60 compatible with scheme 1 and a device 70 compatible with scheme 2.

The device 60 is compatible with the communication scheme (scheme 1) of the device 80 included in the base station 40a and performs wireless communication with the device 80. The device 70 is compatible with the communication scheme (scheme 2) of the device 90 included in the base station 40a and performs wireless communication with the device 90.

The second wireless terminal 30a is compatible with only scheme 1 between schemes 1 and 2. The second wireless terminal 30a is not compatible with communication through scheme 2. The second wireless terminal 30a is a so-called existing device which is not compatible with multi-link. The second wireless terminal 30a includes a device 60 compatible with scheme 1 and serves as an STA that performs wireless communication with the device 80 included in the base station 40a.

The control device 50b is connected to the terminal device 110. The control device 50b controls the first wireless terminal 20 such that the first wireless terminal 20 and the base station 40a perform wireless communication, for example. The control device 50b may have substantially the same configuration as the control device 50a. The terminal device 110 is a computer or the like that controls the control device 50b.

The first wireless terminal 20 may be configured integrally with the control device 50b. That is, the first wireless terminal 20 may have each function of the control device 50b.

The base station 40b includes a device 80 serving as an AP of scheme 1 and performs wireless communication with the third wireless terminal 30b. The third wireless terminal 30b is a wireless terminal having a device 60 compatible with scheme 1. The third wireless terminal 30b performs wireless communication with the base station 40b through scheme 1.

That is, the wireless communication system 10 is a wireless communication system including the first wireless terminal 20 capable of communicating through both a first communication scheme using a first frequency band (for example, 5 GHz) and a second communication scheme using a second frequency band (for example, 6 GHz) higher than the first frequency band, the second wireless terminal 30a that is compatible with communication using the first communication and is not compatible with communication scheme using the second communication scheme, and the base station 40a that is compatible with multi-link and accommodates the first wireless terminal 20 and the second wireless terminal 30a. There may be one or more first wireless terminals 20 accommodated in the base station 40a. Similarly, there may be one or more second wireless terminals 30a accommodated in the base station 40a.

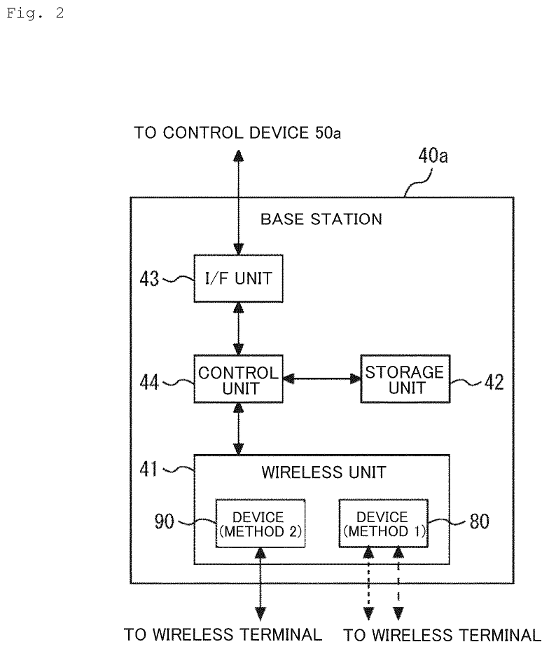

Next, a specific configuration example of the base station 40a will be described. FIG. 2 is a diagram showing a specific configuration example of the base station 40a according to embodiment 1. As shown in FIG. 2, the base station 40a includes, for example, a wireless unit 41, a storage unit 42, an interface (I/F) unit 43, and a control unit 44.

The wireless unit 41 includes the device 80 and the device 90 described above. The wireless unit 41 performs wireless communication with each of wireless terminals accommodated in the base station 40a, that is, the first wireless terminal 20 and the second wireless terminal 30a.

The storage unit 42 stores information or the like received by the base station 40a via the wireless unit 41 or the interface unit 43.

The interface unit 43 is a communication interface that performs communication with the control device 50a.

The control unit 44 controls respective units constituting the base station 40a.

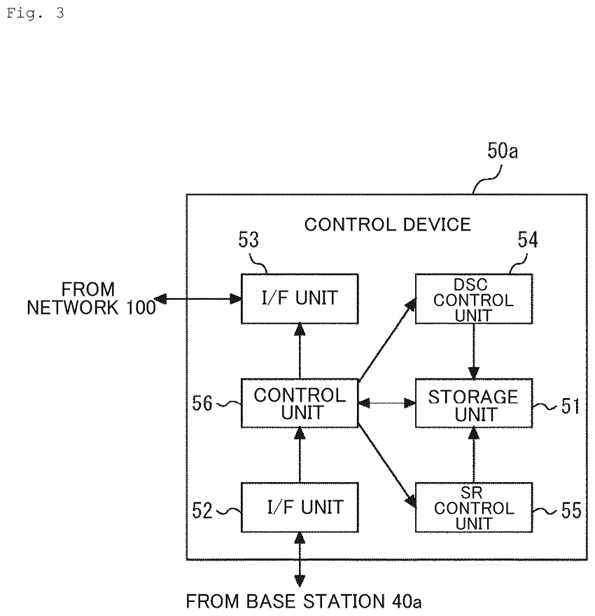

Next, a specific configuration example of the control device 50a will be described. FIG. 3 is a diagram showing a specific configuration example of the control device 50a for controlling the base station 40a according to embodiment 1. As shown in FIG. 3, the control device 50a includes, for example, a storage unit 51, an interface (I/F) unit 52, an interface (I/F) unit 53, and a control unit 56.

The storage unit 51 is a storage device which stores data in the control device 50a.

The interface unit 52 is a communication interface that performs communication with the base station 40a. The interface unit 53 is a communication interface that performs communication with the network 100.

The control unit 56 controls wireless communication by the base station 40a that is a multi-link device by controlling respective units constituting the control device 50a. In the present embodiment, the control unit 56 controls a carrier sense level during transmission in communication between the base station 40a and the first wireless terminal 20.

Control of a carrier sense level can be realized by, for example, a dynamic sensitivity control (DSC) function of a DSC control unit 54 included in the control device 50a. For example, a carrier sense level during transmission in communication between the base station 40a and the second wireless terminal 30a through scheme 1 is set to a predetermined value. For example, the carrier sense level during transmission in communication between the base station 40b and the third wireless terminal 30b is also the predetermined value. The control unit 56 sets the carrier sense level during transmission in communication between the base station 40a and the first wireless terminal 20 through scheme 1 to a value less than the predetermined value.

In a case in which the base station 40a performs communication by the device 80 through scheme 1, for example, the control unit 56 has a function of determining whether or not the communication is MLD communication. The control unit 56 sets the carrier sense level to a value less than the predetermined value upon determining that communication by the base station 40a through scheme 1 is MLD communication, that is, the communication object of the base station 40a is the first wireless terminal 20. Upon determining that communication by the base station 40a through scheme 1 is not MLD communication, that is, the communication object of the base station 40a is the second wireless terminal 30a, the control unit 56 sets the carrier sense level to the predetermined value.

Some or all functions of the control device 50a may be configured by hardware such as a programmable logic device (PLD) or a field programmable gate array (FPGA), or may be configured as a program executed by a processor such as a CPU.

For example, the control device 50a can be realized using a computer and a program, and the program can be recorded on a recording medium or provided via a network.

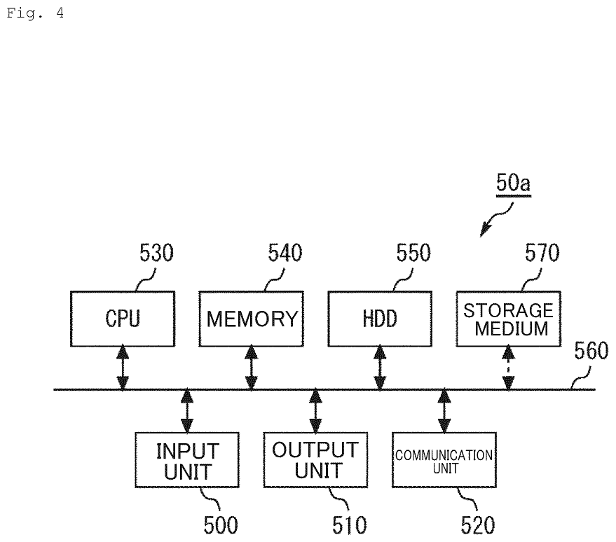

FIG. 4 is a diagram showing a hardware configuration example of the control device 50a for controlling the base station 40a according to embodiment 1. As shown in FIG. 4, the control device 50a includes an input unit 500, an output unit 510, a communication unit 520, a CPU 530, a memory 540, and an HDD 550 which are connected via a bus 560, and functions as a computer. Further, the control device 50a is configured to be able to input/output data to/from a computer-readable storage medium 570.

The input unit 500 is a keyboard, a mouse, and the like, for example. The output unit 510 is a display device such as a display, for example. The communication unit 520 is a network interface or the like, for example.

The CPU 530 controls respective units constituting the control device 50a and performs predetermined processing and the like. The memory 540 and the HDD 550 are storage units that store data and the like.

The storage medium 570 is capable of storing a program or the like for executing the functions of the control device 50a. The architecture constituting the control device 50a is not limited to the example shown in FIG. 4.

As described above, the control device 50b may have substantially the same configuration as the control device 50a. For example, the control device 50b may set a carrier sense level during transmission in communication between the base station 40a and the first wireless terminal 20 through scheme 1 to a value less than a predetermined value. The control device 50b may set the carrier sense level to the predetermined value in a case in which the communication is not MLD communication, such as a case in which the communication object of the first wireless terminal 20 is the base station 40b.

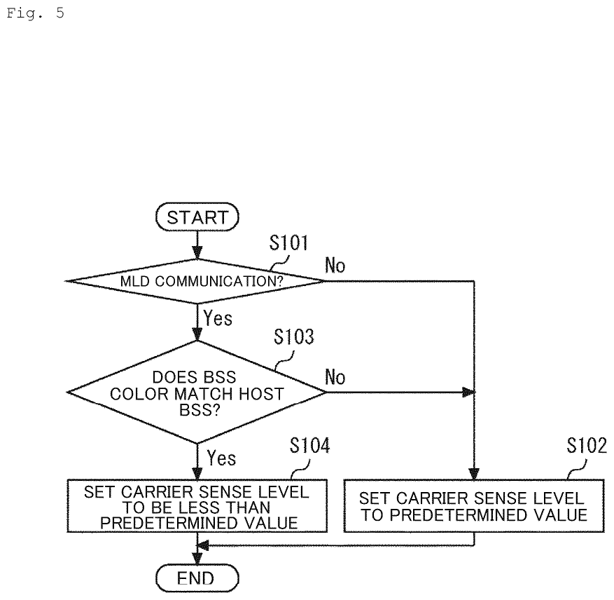

Next, operations and modified examples of the wireless communication system 10 will be described with reference to a flowchart. FIG. 5 is a flowchart showing an operation example of the wireless communication system 10 according to embodiment 1.

The flowchart of FIG. 5 shows an example of an operation of controlling a carrier sense level in a case in which the base station 40a performs communication by the device 80 through scheme 1. First, it is determined whether the communication is MLD communication (step S101). If the communication is not MLD communication, the carrier sense level is set to a predetermined value (step S102).

In this case, in a case in which communication by the device 80 of the base station 40a through scheme 1 is MLD communication, for example, it may be detected that the existing first frequency band is not affected during multi-link by using a spatial reuse (SR) function. That is, it may be detected and determined whether or not a BSS identifier (BSS color) of a received frame in communication between the base station 40a and the first wireless terminal 20 through scheme 1 matches a host BSS (step S103).

In a case in which the BSS identifier of the received frame is different from the host BSS, the carrier sense level may be set to the predetermined value (step S102) because the existing first frequency band is not affected. In a case in which the BSS identifier of the received frame matches the host BSS, the carrier sense level is set to be less than the predetermined value because the existing first frequency band is affected (step S104).

The SR function is realized, for example, by an SR control unit 55 included in the control device 50a. The SR control unit 55 functions as a determination unit having a determination function of step S103, for example. The control unit 56 controls the carrier sense level using the DSC function of the DSC control unit according to the determination result of the SR control unit 55 functioning as a determination unit.

In this manner, the wireless communication system 10 according to the present embodiment is configured to set the carrier sense level during transmission in communication between the base station 40a and the first wireless terminal 20 through the first communication scheme to a value less than a predetermined value that is the carrier sense level during transmission in communication between the base station 40a and the second wireless terminal 30a through the first communication scheme. In wireless communication, a frame transmission opportunity is obtained in a case in which a received signal is equal to or less than a carrier sense level. By reducing the carrier sense level during transmission in communication between the base station 40a and the first wireless terminal 20 through the first communication scheme, a transmission opportunity is relatively hardly obtained. On the other hand, in communication between the base station 40a and the second wireless terminal 30a through the first communication scheme, a transmission opportunity is relatively easily obtained.

In the wireless communication system 10 according to the present embodiment, the second wireless terminal 30a that is an existing device having a higher carrier sense level can obtain a transmission right more preferentially than the first wireless terminal 20 that is a multi-link device in the first frequency band. Accordingly, the total throughput of the second wireless terminal 30a that is an existing device not compatible with multi-link can be improved. According to the present embodiment, in a case in which a multi-link device using both a low frequency band and a high frequency band and an existing device that is no compatible with multi-link and uses the low frequency band coexist, the communication speed of the existing device can be prevented from decreasing. Each function of the wireless communication system 10 and each component constituting the wireless communication system 10, such as the base station 40a, can also be realized by a wireless communication method including each function as a process.

### REFERENCE SIGNS LIST

10 Wireless communication system
20 First wireless terminal
30a Second wireless terminal
30b Third wireless terminal
40a Base station
40b Base station
41 Wireless unit
42 Storage unit
43 Interface unit
44 Control unit
50a Control device
50b Control device
51 Storage unit
52 Interface unit
53 Interface unit
54 DSC control unit
55 SR control unit
56 Control unit
60 Device
70 Device
80 Device
90 Device
100 Network
110 Terminal device
500 Input unit
510 Output unit
520 Communication unit
530 CPU
540 Memory
550 HDD
560 Bus
570 Storage medium

1. A wireless communication system comprising:
a first wireless terminal capable of communicating through both a first communication scheme using a first frequency band and a second communication scheme using a second frequency band higher than the first frequency band;
a second wireless terminal that is compatible with communication through the first communication scheme and is not compatible with communication through the second communication scheme; and
a base station that is compatible with multi-link and accommodates the first wireless terminal and the second wireless terminal,
wherein
a carrier sense level during transmission in communication between the base station and the first wireless terminal through the first communication scheme is set to a value less than a predetermined value that is a carrier sense level during transmission in communication between the base station and the second wireless terminal through the first communication scheme.

2. The wireless communication system according to claim 1, wherein the first communication scheme and the second communication scheme are wireless communication schemes conforming to a wireless LAN standard.

3. The wireless communication system according to claim 1, wherein the carrier sense level during transmission in the communication is set to a value less than the predetermined value in a case in which a BSS identifier of a received frame in communication between the base station and the first wireless terminal through the first communication scheme matches a host BSS, and
the carrier sense level during transmission in the communication is set to the predetermined value in a case in which a BSS identifier of a received frame in communication between the base station and the first wireless terminal through the first communication scheme is different from the host BSS.

4. A wireless communication method of controlling a first wireless terminal capable of communicating through both a first communication scheme using a first frequency band and a second communication scheme using a second frequency band higher than the first frequency band, a second wireless terminal that is compatible with communication through the first communication scheme and is not compatible with communication through the second communication scheme, and a multi-link compatible base station accommodating the first wireless terminal and the second wireless terminal, the wireless communication method comprising
setting a carrier sense level in communication between the base station and the first wireless terminal through the first communication scheme to a value less than a predetermined value that is a carrier sense level in communication between the base station and the second wireless terminal through the first communication scheme.

5. The wireless communication method according to claim 4, wherein the first communication scheme and the second communication scheme are wireless communication schemes conforming to a wireless LAN standard.

6. The wireless communication method according to claim 4, further comprising:
setting the carrier sense level during transmission in the communication to a value less than the predetermined value in a case in which a BSS identifier of a received frame in communication between the base station and the first wireless terminal through the first communication scheme matches a host BSS; and
setting the carrier sense level during transmission in the communication to the predetermined value in a case in which a BSS identifier of a received frame in communication between the base station and the first wireless terminal through the first communication scheme is different from the host BSS.

7. Abase station that is compatible with multi-link and accommodates a first wireless terminal capable of communicating through both a first communication scheme using a first frequency band and a second communication scheme using a second frequency band higher than the first frequency band, and a second wireless terminal that is compatible with communication through the first communication scheme and is not compatible with communication through the second communication scheme,
wherein
a carrier sense level in communication between the base station and the first wireless terminal through the first communication scheme is set to a value less than a predetermined value that is a carrier sense level in communication between the base station and the second wireless terminal through the first communication scheme.

8. The base station according to claim 7, wherein the first communication scheme and the second communication scheme are wireless communication schemes conforming to a wireless LAN standard.
